(19) United States
(12) Patent Application Publication
(10) Pub. No.: US 2018/0241223 A1
(43) Pub. Date: Aug. 23, 2018

(54) WIRELESS POWER TRANSFER SYSTEM AND DRIVING METHOD THEREFOR

(71) Applicant: LG INNOTEK CO., LTD., Seoul (KR)

(72) Inventor: Su Ho BAE, Seoul (KR)

(73) Assignee: LG INNOTEK CO., LTD., Seoul (KR)

(21) Appl. No.: 15/752,138

(22) PCT Filed: Aug. 1, 2016
(86) PCT No.: PCT/KR2016/008472

§ 371 Date: Feb. 12, 2018

(30) Foreign Application Priority Data
Aug. 13, 2015 (KR) 10-2015-0114958

(51) Int. Cl. H02J 7/00; H02J 7/02; H02J 50/12; H02J 50/80

(52) U.S. Cl. CPC H02J 7/007; H02J 50/80; H02J 50/12; H02J 7/025

(57) ABSTRACT

The present invention provides a method of driving a power transfer unit wirelessly transferring power, the method including: detecting a voltage and a current of the power transfer unit; detecting a change in the voltage and the current; and sensing that a battery receiving wireless power from the power transfer unit is being fully charged on the basis of the change in the voltage and the current.

### TECHNICAL FIELD

The present invention relates to a wireless power transfer system and a method of driving the wireless power transfer system.

### BACKGROUND ART

In general, various electronic devices are equipped with a battery and use the power stored in the battery. The batteries of electronic devices can be replaced and can also be recharged. To this end, electronic devices have a contact terminal for connecting an external charger. That is, electronic devices are electrically connected with a charger through the contact terminal. However, since the contact terminals of electronic device are exposed to the outside, they may be contaminated by dirt or a short circuit may occur due to humidity. In these cases, there is a problem that the batteries of electronic devices are not charged due to poor contact between a contact terminal and a charger.

In order to solve this problem, wire power transfer (WPT) has been proposed to wirelessly charge electronic devices.

Wireless power transfer, which is a technology of transferring power through a space without a wire, is a technology that maximizes convenience in supplying power to mobile devices and digital appliances.

A wireless power transfer system has advantages such as saving energy by controlling power consumption in real time, overcoming a spatial limit in power supply, and reducing the amount of waste of batteries by recharging batteries.

A magnetic induction method and a magnetic resonance method are representative of methods of implementing a wireless power transfer system. The magnetic induction method is a non-contact energy transfer technology that supplies a current to one of two coils disposed close to each other to generate magnetic flux, thereby generating an electromotive force at the other coil, and can use frequencies of hundreds of kHz. The magnetic resonance method, which is a technology that uses only an electric field or a magnetic field without using electromagnetic waves or a current, has over several meters of available power transfer distance and can use bands of several MHz.

A wireless power transfer system includes a transmitter that wirelessly transfers power and a receiver that receives power and charges loads such as a battery. A charge method by receivers, that is, any one of the magnetic induction method and the magnetic resonance method can be selected and transmitters that can wirelessly transfer power in correspondence to the charge methods by receivers have been developed.

When the battery of a receiver is fully charged, a transmitter does not recognize this fact and keeps transferring power, so power is lost and the temperature of the transmitter and receiver is increased due to heat generation thereof.

### DISCLOSURE

### Technical Problem

An embodiment provides a wireless power transfer system for solving the problem of a loss of power and heat generation when it is not recognized that a battery has been fully charged, by stopping wireless power transfer by sensing that the battery has been fully charged, using a power receiver unit, even if a power transfer unit does not receive a separate message from the power receiver unit.

### Technical Solution

An embodiment provides a method of driving a power transfer unit wirelessly transferring power, the method including: determining a change in a voltage and a current of the power transfer unit; and determining whether a battery in a power receiver unit receiving wireless power from the power transfer unit is being fully charged on the basis of a change in the voltage and the current.

An embodiment provides a method of driving a power transfer unit, in which the determining of a change in a voltage and a current measures values of the voltage for a predetermined time and detects whether the measured values of the voltage are reduced, and measures values of the current for a predetermined time and determines whether the measured values of the current are maintained.

An embodiment provides a method of driving a power transfer unit, in which the determining whether the current is reduced determines whether the voltage is reduced step by step.

An embodiment provides a method of driving a power transfer unit, in which when the battery is being fully charged, wireless power transfer is stopped.

An embodiment provides a method of driving a power transfer unit, in which the voltage of an output voltage of a DC/DC converter of the power transfer unit, and the current is an output current of a DC/DC converter of the power transfer unit.

An embodiment provides a method of driving a power transfer unit, in which a change in a voltage of the power transfer unit is determined on the basis of an output voltage instruction value of the DC/DC converter.

An embodiment provides a method of driving a power transfer unit, in which the voltage and the current are an input voltage and an input current of a transfer-side coil of the power transfer unit.

An embodiment provides a method of driving a power receiver unit charging a batter by wirelessly receiving power from a power transfer unit, the method including: reducing step by step a current applied to the battery when a charge amount of the battery is a first charge amount to a second charge amount larger than the first charge amount; determining whether power is transferred from the power transfer unit recognizing a reduction of the current; and determining that the battery has been fully charged when power transfer from the power transfer unit is stopped.

An embodiment provides a method of driving a power receiver unit, in which the first charge amount is a charge amount indicating a full charge start state of the battery, the second charge amount is a charge amount indicating a full charge completion state of the battery, and when the charge amount of the battery is within the range of the first to second charge amounts, the battery is being fully charged.

An embodiment provides a method of driving a power receiver unit, in which a voltage applied to the battery in the reducing of a current applied to the battery is constant.

An embodiment provides a power transfer unit wirelessly transferring power, including: a DC/DC converter; and a controller determining whether a battery of a power receiver unit, which receives wireless power from the power transfer unit, is being fully charged on the basis of a change in an output signal of the DC/DC converter.

An embodiment provides a power transfer unit, in which the output signal is an output current and an output voltage of the DC/DC converter.

An embodiment provides a power transfer unit, the power transfer unit further including a detector detecting the output current and the output voltage.

An embodiment provides a power transfer unit, the power transfer unit further including a detector detecting the output current, in which the controller adjusts an output voltage for the DC/DC converter on the basis of an output voltage instruction value, and the controller determines a change in the output voltage on the basis of the output voltage instruction value.

An embodiment provides a power transfer unit, in which whether the output current is constant and the output voltage is reduced step by step for a predetermined time is determined.

An embodiment provides a power transfer unit, in which whether the output current is constant and the output voltage instruction value is reduced step by step for a predetermined time is determined.

An embodiment provides a power transfer unit, in which when the power transfer unit determines that the battery is being fully charged, the power transfer unit stops wireless power transfer after a predetermined time passes.

An embodiment provides a power receiver unit wirelessly receiving power from a power transfer unit, including: a receiver-side coil receiving the power; a battery charged with the power; and a battery manager controlling the battery, in which the battery manager reduces step by step a current applied to the battery when a charge amount of the battery is a first charge amount to a second charge amount larger than the first charge amount, and determines that the battery has been fully charged when power transfer from the power transfer unit recognizing the reduction of the current is stopped.

An embodiment provides a power receiver unit, in which the battery manager determines that the first charge amount is a charge amount indicating a full charge start state of the battery, that the second charge amount is a charge amount indicating a full charge completion state of the battery, and that the battery is being fully charged when the charge amount of the battery is within the range of the first to second charge amounts.

An embodiment provides a power receiver unit, in which the power receiver unit receives a message of stopping wireless power transfer from the power transfer unit recognizing the reduction of the current.

### Advantageous Effects

According to an embodiment, even if a power transfer unit does not receive a separate message from a power receiver unit, it is possible to sense that a battery of the power receiver unit has been fully charged. Accordingly, it is possible to remove a risk due to non-reception of a message between the power transfer unit and the power reception unit. Further, when the power transfer unit receives a full charge message after the power receiver unit is fully charged, it is possible to prevent unnecessary waste of power between the units. Further, since the power transfer unit determines whether to stop wireless power transfer by determining by itself the charge state of a load, it is possible to a loss of power and heat generation due to non-recognition of full charge completion of the battery.

### BRIEF DESCRIPTION OF THE DRAWINGS

FIG. 1 is diagram showing a magnetic induction equivalent circuit.

FIG. 2 is diagram showing a magnetic resonance equivalent circuit.

FIGS. 3A and 3B are block diagrams showing a power transfer unit that is one of sub-systems constituting a wireless power transfer system;

FIGS. 4A and 4B are block diagrams showing a power receiver unit that is one of sub-systems constituting a wireless power transfer system;

FIG. 5 is a diagram showing the operation flow of a wireless power transfer system, based on the operation state of a power transfer unit according to an embodiment;

FIG. 6 is a diagram showing the operation flow of a wireless power transfer system, based on the operation state of a power transfer unit according to another embodiment;

FIG. 7 is a diagram showing the operation flow of a wireless power transfer system according to another embodiment;

FIGS. 8A and 8B are equivalent circuit diagrams of a power transfer unit and a power receiver unit;

FIG. 9 is a flowchart of driving a power transfer unit according to an embodiment;

FIG. 10 is a flowchart of driving a power receiver unit according to an embodiment; and

FIG. 11 is a graph showing the magnitude of a current applied to a battery in accordance with a full charge state of the battery over time.

### BEST MODE FOR THE INVENTION

A wireless power transfer system including a power transfer unit having a function of wirelessly transmitting power and a power receiver unit wirelessly receiving power according to an embodiment of the present invention is described hereafter in detail with reference to the drawings. Embodiments to be described hereafter are provided as examples for sufficiently communicating the spirit of the present invention to those skilled in the art. Accordingly, the present invention is not limited to the following embodiments and may be implemented by other ways. The sizes, thicknesses, etc. of devices may be exaggerated for convenience in the drawings. The like reference numerals indicate substantially the like components throughout the specification.

Embodiments may include a communication system that selectively uses various frequency bands from a low frequency (50 kHz) to a high frequency (15 MHz) to wirelessly transfer power and can exchange data and control signals for system control.

Embodiments can be applied to various industrial fields such as a mobile terminal industry using electronic devices, which use or require a battery, a smart watch industry, a computer and notebook industry, an appliance industry, an electric vehicle industry, a medical device industry, and a robot industry.

Embodiments may consider a system that can transfer power to one or more devices, using one or more transfer coils.

According to embodiments, it is possible to the problem of a deficit of power in a battery for mobile devices such as a smartphone and a notebook, and for example, when a smartphone and a notebook are used on a wireless charger pad on a table, batteries are automatically charged and can be used for a long time. Further, it is possible to charge and use various mobile devices regardless of charging terminals that are different by mobile device manufacturers only by installing a wireless charger pad in public places such as a cafe, an airport, a taxi, an office, and a restaurant. Further, when a wireless power transfer technology is applied to home appliances such as a cleaner and an electric fan, it is not required to look for a power cable, disarranged electric wires cannot be cleared in houses, electric wires in building can be reduced, and spatial availability can be increased. Further, at present, it takes long time to charge an electric vehicle with the electricity for home use, but if high power is transmitted by a wireless power transfer technology, the charging time can be reduced. Furthermore, if a wireless charging facility is installed on the floor of a parking place, it is possible to clear up the inconvenience that there is a need for preparing a power cable around an electric vehicle.

Terminologies and abbreviations that are used in embodiments are as follows.

Wireless power transfer system: A system that provides wireless power transfer in a magnetic field area.

Wireless power transfer system-charger; Power transfer unit (PTU): A device that provides wireless power transfer to a power receiver unit in a magnetic field area and it may be referred to a transfer device or a transmitter.

Wireless power receiver system-device; Power receiver unit (PRU): A device that receives wireless power transfer from a power transfer unit in a magnetic field area and it may be referred to as a reception device or a receiver.

Charging area: An area where wireless power transfer is performed in a magnetic field area and it may change in accordance with the sizes of application products, requested power, and an operation frequency.

S scattering parameter: A ratio of an output voltage to an input voltage in frequency distribution and it may be a ratio of an output port to an input port (transmission; S₂₁), or a reflection value of each of input/output ports, that is, an output value (reflection; S₁₁, S₂₂) that is reflected back by its input.

Quality factor (Q): Q in resonance is a quality of frequency selection, the higher the Q, the better the resonance characteristic, and Q may be expressed as a ratio of energy kept in an resonator and lost energy.

The principle of wirelessly transferring power may be classified into a magnetic induction method and a magnetic resonance method.

The magnetic induction method is a non-contact energy transfer technology that puts a source inductor Lₛ and a load inductor Lₗ and supplies a current to the source inductor Lₛ to generate magnetic flux, thereby generating an electromotive force at the load inductor Lₗ. The magnetic resonance method is a technology that wirelessly transfers energy using a resonance scheme in which two resonators are coupled and magnetic resonance is generated by a natural frequency between the resonators, so the resonators are vibrated at the same frequency, thereby generating an electric field and a magnetic field within the same wavelength range.

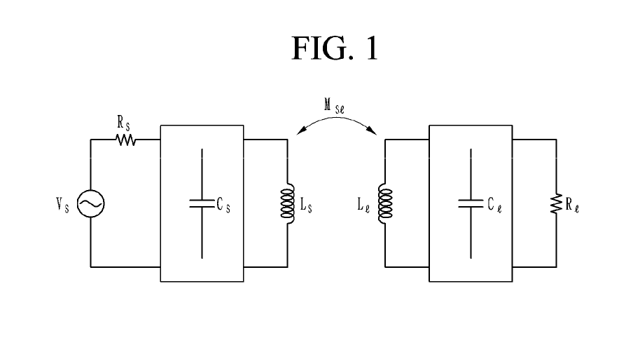

FIG. 1 is diagram showing a magnetic induction equivalent circuit.

Referring to FIG. 1, in the magnetic induction equivalent circuit, a power transfer unit may be implemented by a source voltage Vₛ and a source resistor Rₛ according to a device that supplies power, a source capacitor Cₛ for impedance matching, and a source coil Lₛ for magnetic coupling with a power receiver unit, and the power receiver unit may be implemented by a load resistor Rₗ that is an equivalent resistor, a load capacitor Cₗ for impedance matching, and a load coil Lₗ for magnetic coupling with the power transfer unit, in which the degree of magnetic coupling of the source coil Lₛ and the load coil Lₗ can be expressed as mutual inductance Mₛₗ.

When a ratio S₂₁ of an output voltage to an input voltage is obtained from a magnetic induction equivalent circuit composed of only coils without a source capacitor Cₛ and a load capacitor Cₗ for impedance matching and the maximum power transfer condition is found from the ratio, the maximum power transfer condition satisfies the following Equation 1.

Lₛ/Rₛ=Lₗ/Rₗ Equation 1

When a ratio of the inductance of the transfer coil Lₛ and the source resistor Rₛ and a ratio of the inductance of the load coil Lₗ and the load resistor Rₗ are the same in Equation 1, the maximum power transfer is possible. In a system having only inductance, there is no capacitor that can compensate for reactance, so the reflection value S₁₁ of an I/O port cannot be 0 at the point where the maximum power is transmitted, and the power transmission efficiency can be largely changed in accordance with mutual inductance Mₛₗ. Accordingly, a source capacitor Cₛ may be added to a power transfer unit as a compensation capacitor for impedance matching and a load capacitor Cₗ may be added to the power receiver unit. The compensation capacitors Cₛ and Cₗ, for example, may be connected in series or in parallel to a reception coil Lₛ and a load coil Lₗ, respectively. Further, not only the compensation capacitors, but passive devices such as additional capacitors and inductors may be further added to the power receiver unit and the power transfer unit for impedance matching.

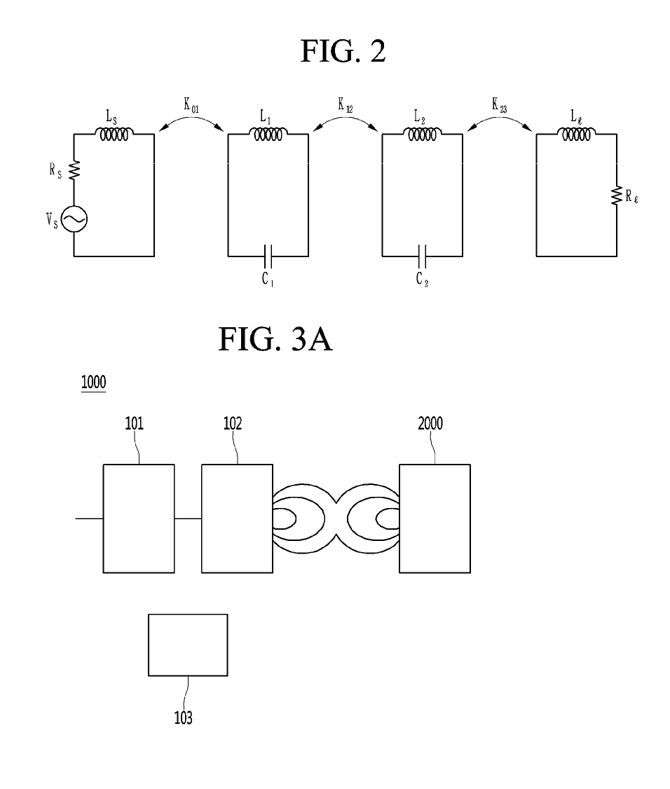

FIG. 2 is diagram showing a magnetic resonance equivalent circuit.

Referring to FIG. 2, in the magnetic resonance equivalent circuit, the power transfer unit is implemented by a source coil forming a closed circuit by connecting a source voltage Vₛ, a source resistor Rₛ, and a source inductor Lₛ in series, and a transfer-side resonant coil forming a closed circuit by connecting a transfer-side resonant inductor L₁ and a transfer-side resonant capacitor C₁ in series. Further, a power receiver unit is implemented by a load coil forming a closed circuit by connecting a load resistor Rₗ and a load inductor Lₗ and a reception-side resonant coil forming a closed circuit by connecting a reception-side resonant inductor L₂ and a reception-side resonant capacitor C₂ in series. Further, the source inductor Lₛ and the transfer-side resonant inductor L₁ are magnetically coupled with a coupling coefficient K₀₁, the load inductor Lₗ and the load-side resonant inductor L₂ are magnetically coupled with a coupling coefficient K₂₃, and the reception-side resonant inductor L₁ and the reception-side resonant inductor L₂ are magnetically coupled with a coupling coefficient K₁₂. An equivalent circuit according to another embodiment may be composed of only a transfer-side resonant coil and a reception-side resonant coil without a source coil and/or a load coil.

According to the magnetic induction method, when the resonant frequencies of two resonator are the same, most of the energy of the resonator of a power transfer unit is transmitted to the resonator of the power receiver unit, so the power transmission efficiency can be improved, and the efficiency in the magnetic resonance method is improved when the following Equation 2 is satisfied.

k/Γ>>1 (k is a coupling coefficient and Γ is a damping rate) Equation 2

In the magnetic resonance method, a device for impedance matching may be added to increase the efficiency and the impedance matching device may be a passive device such as an inductor and a capacitor.

A wireless power transfer system for transmitting power, using the magnetic induction method or the magnetic resonance method, on the basis of the wireless power transfer principle described above is described hereafter.

<Power Transfer Unit>

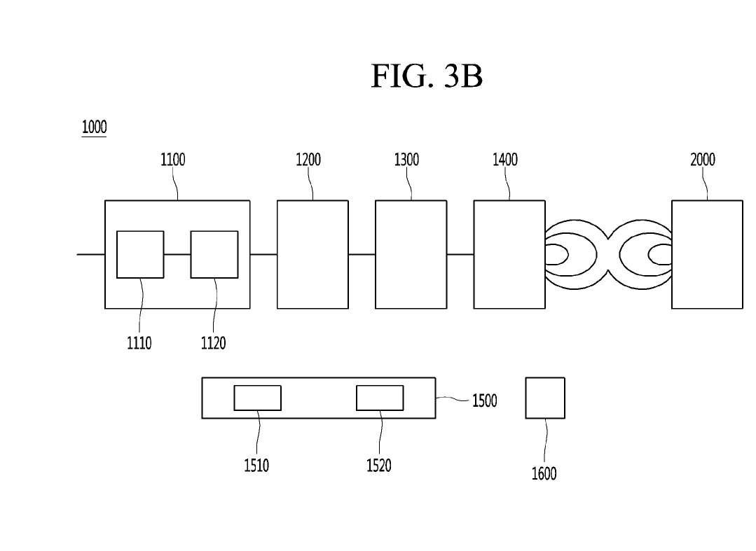

FIGS. 3A and 3B are block diagrams showing a power transfer unit that is one of sub-systems constituting a wireless power transfer system.

Referring to FIG. 3A, a wireless power transfer system according to an embodiment may include a power transfer unit 1000 and a power receiver unit 2000 that wirelessly receives power from the power transfer unit 1000. The power transfer unit 1000 may include: a transfer-side power converter 101 that outputs an AC signal by performing power conversion on an input AC signal; a transfer-side resonant circuit unit 102 that provides power to the power receiver unit 2000 in a charging area by generating a magnetic field on the basis of the AC signal output from the transfer-side power converter 101; a transfer-side controller 103 that controls power conversion of the transfer-side power converter 101, adjusts the amplitude and frequency of the output signal from the transfer-side power converter 101, performs impedance matching of the transfer-side resonant circuit unit 102, senses impedance, voltage, and current information from the transfer-side power converter 101 and the transfer-side resonant circuit unit 102, and can perform wireless communication with the power receiver unit 2000. The transfer-side power converter 101 may include at least one of a power converter that converts an AC signal into a DC signal, a power converter that outputs a DC by varying the level of a DC, and a power converter that converts a DC into an AC. The transfer-side resonant circuit unit 102 may include a coil and an impedance matching unit that can resonate with the coil. The transfer-side controller 103 may include a sensing unit for sensing impedance, voltage, and current information, and a wireless communication unit.

Further, referring to FIG. 3, the power transfer unit 1000 may include a transfer-side AC/DC converter 1100, a transfer-side DC/AC converter 1200, a transfer-side impedance matching unit 1300, a transfer coil unit 1400, and a transfer-side communication & control unit 1500.

The transfer-side AC/DC converter 1100, which is a power converter that converts an AC signal provided from the outside into a DC signal under control of the transfer-side communication & control unit 1500, may include a rectifier 1110 and a transfer-side DC/DC converter 1120 that are sub-systems. The rectifier 1110, which is a system that converts a provided AC signal into a DC signal, for example, may be a diode rectifier that has relatively high efficiency in high-frequency operation, a synchronous rectifier that can be implemented into one chip, or a hybrid rectifier that can save the manufacturing cost and a space and has high degree of freedom of dead time. However, the rectifier is not limited thereto and any system that converts an AC into a DC can be applied. The transfer-side DC/DC converter 1120, which adjusts the level of a DC signal provided from the rectifier 1110 under control of the transfer-side communication & control unit 1500, for example, may be a buck converter that decreases the level of an input signal, a boost converter that increases the level of an input signal, or a buck boost converter or a cuk converter that deceases or increases the level of an input signal. The transfer-side DC/DC converter 1120 may include: an inductor and a capacitor that function as a switch device and a power conversion medium, which perform power conversion control function, or that perform a power smoothing function; and a transformer that adjusts a voltage gain or performs an electrical separation function (insulating function). Further, the transfer-side DC/DC converter 1120 can remove a ripple component or a pulsation component included in an input AC signal (an AC component included in a DC signal). The difference between a command value of an output signal of the transfer-side DC/DC converter 1120 and the actual output value can be adjusted through feedback, which may be achieved by the transfer-side communication & control unit 1500.

The transfer-side DC/AC converter 1200, which is a system that can convert a DC signal output from the transfer-side AC/DC converter 1100 into an AC signal and can adjust the frequency of the converted AC signal under control of the transfer-side communication & control unit 1500, for example, may be a half bridge inverter or a full bridge inverter. The wireless power transfer system may include various amplifiers that convert a DC into an AC, and for example, there are A-class, B-class, AB-class, C-class, E-class, and F-class amplifiers. The transfer-side DC/AC converter 1200 may include an oscillator that generates a frequency of an output signal and a power amplifier that amplifies an output signal.

The transfer-side AC/DC converter 1100 and the transfer-side DC/AC converter 1200 may be replaced by an AC power supplier, or may be removed or replaced by other components.

The transfer-side impedance matching unit 1300 improves flow of a signal by minimizing a reflected wave at points having different impedances. The two coils of the power transfer unit 1000 and the power receiver unit 2000 are spatially separated, so there is a lot of leakage of magnetic field, so it is possible to improve power transmission efficiency by correcting the impedance difference between two connection terminals of the power transfer unit 1000 and the power receiver unit 2000. The transfer-side impedance matching unit 1300 may be composed of at least one of an inductor, a capacitor, and a resistor and can adjust an impedance value for impedance matching by varying inductance of the inductor, capacitance of the capacitor, and a resistance value of the resistor under control by the communication & control unit 1500. When the wireless power transfer system transfers power, using the magnetic induction method, the transfer-side impedance matching unit 1300 may have a serial constant structure of a parallel resonant structure, and it is possible to minimize a loss of energy by increasing the induction coupling coefficient between the power transfer unit 1000 and the power receiver unit 2000. When the wireless power transfer system transfers power, using the magnetic resonance method, the transfer-side impedance matching unit 1300 can correct in real time impedance matching according to a matching impedance change on an energy transfer line when the distance between the power transfer unit 1000 and the power receiver unit 2000 is changed or the characteristics of a coil is changed by metallic foreign objects (FO) or interaction of a plurality of device, in which as the correcting method, multi-matching that uses a capacitor, matching that uses multi-antennas, and matching that uses multi-loops, etc. may be used.

The transfer-side coil 1400 may be implemented by a plurality of coils or one coil, and when a plurality of transfer-side coils 1400 is provided, they may be spaced from each other or overlap each other. Further, when the transfer-side coils overlap each other, the overlap areas may be determined in consideration of a difference in magnetic flux. When the transfer-side coil 1400 is manufactured, internal resistance and radiation resistance, and in this case, when the resistance component is small, the quality factor and the transfer efficiency can be increased.

The communication & control unit 150 may include a transfer-side controller 1510 and a transfer-side communication unit 1520. The transfer-side controller 1510 can adjust an output voltage of the transfer-side AC/DC converter 1100 (or the current flowing through a transfer coil Iₜₓ_{_}_{coil}) in consideration of one or more of a requested amount of power of the power receiver unit 2000, the current changing amount, a voltage V_{rect} at the output terminal of the rectifier of the power receiver unit, charging efficiency of each of a plurality of power receiver units, and a wireless power method. Further, it is possible to create a frequency and switching waves for driving the transfer-side DC/AC converter 1200 and control power to be transferred, in consideration of the maximum power transfer efficiency. Further, it is possible to control the entire operation of the power receiver unit 2000, using an algorithm, a program, or an application that is required to control and read out from a storage unit (not shown) of the power receiver unit 2000. The transfer-side controller 1510 may be referred to as a microprocessor, a micro control unit, or a micom. The transfer-side communication unit 1520 can communicate with a reception-side communication unit 2620 and may use a near field communication method such as Bluetooth, NFC, and Zigbee. The transfer-side communication unit 1520 and the reception-side communication unit 2620 can transmit and receive charge situation information, charge control instructions to and from each other. The charge situation information may include the number of the power receiver units 2000, a battery level, the number of times of charging, a battery capacity, a batter ratio, the power transfer amount of the power receiver unit 1000, etc. The transfer-side communication unit 1520 can receive a charge function control signal for controlling a charge function of the power receiver unit 2000 and the charge function control signal may be a control signal that enables or disables the charge function by controlling the power receiver unit 2000.

The transfer-side communication unit 1520 may perform communication in an out-of-band type configured in a separate module, but it is not limited thereto and may perform communication in an in-band type in which a power receiver unit uses a feedback signal that is transmitted to a power transfer unit, using a power signal transmitted from the power transfer unit and the power transfer unit transmits a signal to the power receiving unit, using frequency shift of the power signal transmitted from the power transfer unit. For example, a power receiver unit may transmit information such as start of charge, end of charge, and a battery state to a transmitter through a feedback signal by modulating the feedback signal. The transfer-side communication unit 1520 may be configured separately from the transfer-side controller 1510 and the reception-side communication unit of the power receiver unit 2000 may be included in a controller 2610 of the power receiver unit or may be separately configured.

A power transfer unit 1000 of a wireless power transfer system according to another embodiment may further include a detector 1600.

The detector 1600 can detect at least one of an input signal of the transfer-side AC/DC converter 1100, an output signal of the transfer-side AC/DC converter 1100, an input signal of the transfer-side DC/AC converter 1200, an output signal of the transfer-side DC/AC converter 1200, an input signal of the transfer-side impedance matching unit 1300, an output signal of the transfer-side impedance matching unit 1300, an input signal of the transfer-side coil 1400, and an output signal of the transfer-side coil 1400. For example, the signals may include at least one of information about a current, information about a voltage, and information about impedance. Detected signals are fed back to the communication & control unit 1500 and the communication & control unit 1500 can control the transfer-side AC/DC converter 1100, transfer-side DC/DC converter 1120, and transfer-side impedance matching unit 1300 on the basis of the feedback. The communication & control unit 1500 can perform foreign object detection (FOD) on the basis of the detection result. The detected signal may be at least one of a voltage and a current. The detector 1600 may be configured as hardware different from the communication & control unit 1500 or may be implemented as one piece of hardware.

<Power Receiver Unit>

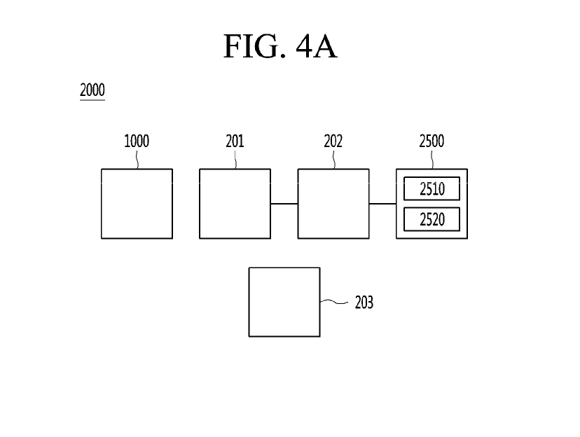

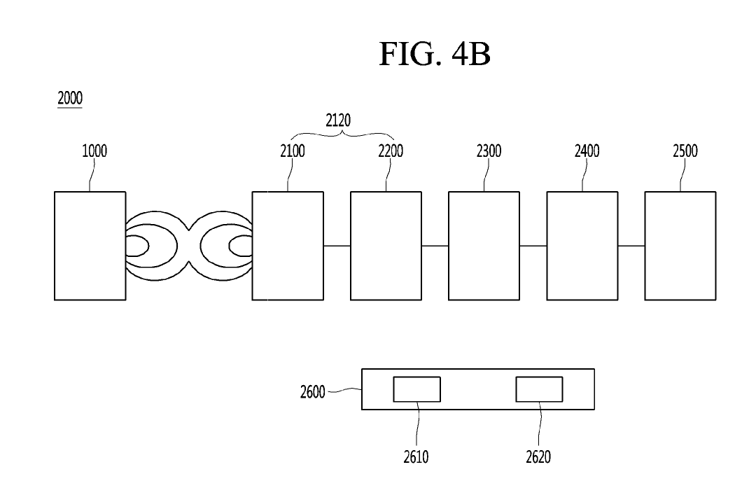

FIGS. 4A and 4B are block diagrams showing a power receiver unit (or a receiver) that is one of sub-systems constituting a wireless power transfer system.

Referring to FIG. 4A, a wireless power transfer system according to an embodiment may include a power transfer unit 1000 and a power receiver unit 2000 that wirelessly receives power from the power transfer unit 1000. The power transfer unit 2000 may include: a reception-side resonant circuit 201 that receives an AC signal transmitted from the power transfer unit 1000; a reception-side power converter 202 that outputs a DC signal by performing power conversion on an AC current from the reception-side resonant circuit unit 201; and a reception-side controller 203 that can sense current voltages of a load 2500, which is charged by receiving a DC signal output from the reception-side converter 202, and the reception-side resonant circuit unit 201, perform impedance matching of the reception-side resonant circuit unit 201, or control power conversion of the reception-side power converter 202, and can adjust the level of an output signal of the reception-side power converter 202, sense an input or output voltage or current of the reception-side power converter 202, control whether to supply the output signal of the reception-side power converter 202 to the load 2500, or communicate with the power transfer unit 1000. The reception-side power converter 202 may include a power converter that converts an AC signal into a DC signal, a power converter that outputs a DC by varying the level of a DC, and a power converter that converts a DC into an AC.

Referring to FIG. 4B, a wireless power transfer system according to an embodiment may include a power transfer unit (or a transmitter) 1000 and a power receiver unit (or a receiver) 2000 that wirelessly receives power from the power transfer unit 1000. The power receiver unit 2000 may include a reception-side resonant circuit unit 2120 composed of a reception-side coil unit 2100 and a reception-side impedance matching unit 2200, a reception-side AC/DC converter 2300, a DC/DC converter 2400, a load 2500, and a reception-side communication & control unit 2600. The reception-side AC/DC converter 2300 may be referred to as a rectifier that rectifies an AC signal into a DC signal.

The reception-side coil unit 2100 can receive power through the magnetic induction method or the magnetic resonance method. The reception-side coil unit 2100 may include one or more of an induction coil or a resonant coil, depending on the power reception method.

For example, the reception-side coil unit 2100 may be disposed in a mobile terminal together with an antenna for near field communication (NFC). The reception-side coil unit 2100 may be the same as the transfer-side coil unit 1400 and the dimensions of the receiving antenna may depend on the electrical characteristic of the power receiver unit 200.

The reception-side impedance matching unit 2200 perform impedance matching between the power transfer unit 1000 and the power receiver unit 2000.

The reception-side AC/DC converter 2300 generates a DC signal by rectifying an AC signal output from the reception-side coil unit 2100. The output voltage of the reception-side AC/DC converter 2300 may be referred to as a rectified voltage V_{rect}, and the reception-side communication & control unit 2600 can detect or change the output voltage of the reception-side AC/DC converter 2300 and can transmit state parameter information such as information about a minimum rectified voltage V_{rect}_{_}ₘᵢₙ (or referred as a minimum output voltage V_{rect}_{_}ₘᵢₙ)that is the minimum value of the output voltage of the reception-side AC/DC converter 2300, a maximum rectified voltage V_{rect}_{_}ₘₐₓ (or referred to as a maximum output voltage V_{rect}_{_}ₘₐₓ) that is the maximum value of the output voltage, and an optimum rectified voltage V_{rect}_{_}ₛₑₜ (or referred to as an optimum output voltage V_{rect}_{_}ₛₑₜ) that has any one voltage value of values between the minimum value and the maximum value.

The reception-side DC/DC converter 2400 can adjust the level of the DC signal output from the reception-side AC/DC converter 2300 to fit the capacity of the load 2500.

The load 2500 may include a battery, a display, a voice output circuit, a main processor, a battery manager, and various sensors. The load 2500, as in FIG. 4A, may include at least a battery 2510 and a battery manager 2520. The battery manager 2520 can adjust a voltage and a current that are applied to the battery 2510 by sensing the chare phase of the battery 2510.

The reception-side communication & control unit 2600 can be activated by wake-up power from the transfer-side communication & control unit 1500, communicate with the transfer-side communication & control unit 1500, and control the operation of the sub-systems of the power receiver unit 2000.

One or a plurality of power receiver units 2000 may be provided and can wirelessly simultaneously receive energy from the power transfer unit 1000. That is, in a wireless power transfer system using the magnetic resonance method, a plurality of target power receiver units 2000 can receive power from one power transfer unit 1000. The transfer-side matching unit 1300 of the power transfer unit 1000 can adaptively perform impedance matching among a plurality of power receiver units 2000. This can be applied in the same way even though a plurality of independent reception-side coil units is provided in the magnetic induction method.

When a plurality of power receiver units 2000 is provided, they may be systems that use the same power reception method or different power reception types. In this case, the power transfer unit 1000 may be a system that transfers power, using magnetic induction or magnetic resonance, or a system that uses both of magnetic induction and magnetic resonance.

The relationship between the magnitude and the frequency of a signal in a wireless power transfer system is described. In wireless power transfer using the magnetic induction method, in the power transfer unit 1000, the transfer-side AC/DC converter 1100 can receive and convert an AC signal of a tens of or hundreds of voltage (for example 110V˜220V) at a tens of or hundreds of hertz (for example, 60 Hz) into a DC signal of a several to hundreds or hundreds of voltage (for example 10V˜20V) and output the DC signal, and the transfer-side DC/AC converter 1200 can receive a DC signal and output an AC signal at KHz (for example 125 KHz). The reception-side AC/DC converter 2300 of the power receiver unit 2000 can receive and convert an AC signal at KHz (for example, 125 KHz) into a DC signal of a several to hundreds or hundreds of voltage (for example 10V˜20V) and output the DC signal, and the reception-side DC/DC converter 2400 can output and transmit a DC signal suitable for the load 2500, for example, a DC signal of 5V to the load 2500. In wireless power transfer using the magnetic resonance method, in the power transfer unit 1000, the transfer-side AC/DC converter 1100 can receive and convert an AC signal of a tens of or hundreds of voltage (for example 110V˜220V) at a tens of or hundreds of hertz (for example, 60 Hz) into a DC signal of a several to hundreds or hundreds of voltage (for example 10V˜20V) and output the DC signal, and the transfer-side DC/AC converter 1200 can receive a DC signal and output an AC signal at MHz (for example 6.78 MHz). The reception-side AC/DC converter 2300 of the power receiver unit 2000 can receive and convert an AC signal at MHz (for example, 6.78 MHz) into a reception-side DC signal of a several to hundreds or hundreds of voltage (for example 10V ˜20V) and output the reception-side DC signal, and the reception-side DC/DC converter 2400 can output and transmit a DC signal suitable for the load 2500, for example, a DC signal of 5V to the load 2500.

<Operation State of Power Transfer Unit>

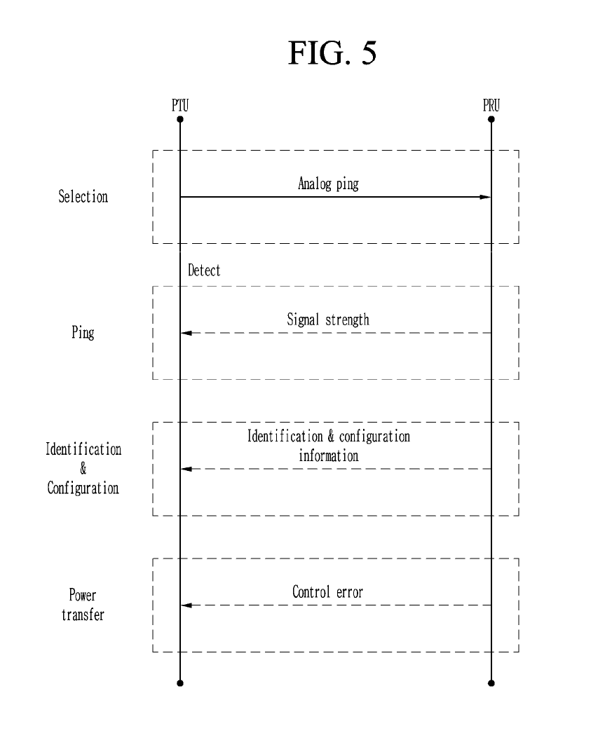

FIG. 5 is a diagram showing the operation flow of a wireless power transfer system, based on the operation state of a power transfer unit according to an embodiment.

Referring to FIG. 5, a power transfer unit according to an embodiment may have 1) a selection phase, 2) a ping phase, 3) an identification and configuration phase, 4) a power transfer phase, and 5) an end of charge phase.

[Selection Phase]

(1) In the selection phase, the power transfer unit 1000 can perform a detection process to select a power receiver unit in a sensing area or a charge area.

(2) The sensing area or the charge area, as described above, may refer to areas in which an object can influence a power characteristic of the transfer-side power converter 101. Compared with the ping phase, a detection process for selecting a power receiver unit 2000 in the selection phase is a process of checking whether there is an object in a predetermined range by sensing a change in a power amount for generating wireless power signal by the power converter of the power transfer unit 1000 instead of receiving a response from the power receiver unit 2000, using a power control message. The detection process in the selection phase may be referred to as an analog ping because it detects an object using not a digital format packing, but a wireless power signal in the ping phase to be described below.

(3) In the selection phase, the power transfer unit 1000 can sense an object coming into and going out of the sensing area or charge area. The power transfer unit 1000 can discriminate the power receiver unit 2000 that can wirelessly transfer power and other objects (for example, a key and a coin) in objects in the sensing area or charge area.

As described above, the distances to which power can be wirelessly transferred are different, depending on the induction coupling method and the resonant coupling method, so the sensing areas where an object is detected in the selection phase may be different.

(4) First, when power is transferred in accordance with an induction coupling method, the power transfer unit 1000 in the selection phase can monitor an interface surface (not shown) to sense disposition and removal of objects.

The power transfer unit 1000 can also sense the location of a power receiver unit placed on the interface surface.

(5) When the power transfer unit 1000 includes one or more transfer coils, it can enter the ping phase from the selection phase and perform a method of checking whether a response to a detection signal has been transmitted from the object, using the coils, and there after, it can enter the identification phase and perform a method of checking whether identification information is transmitted from the object.

The power transfer unit 1000 can determine a coil to use for wireless power transfer on the basis of the location of the power receiver unit 2000 obtained through this process.

(6) When power is transferred in a resonant coupling method, the power transfer unit 1000 in the selection phase can detect an object by sensing a change in one or more of the frequency, current, and voltage of the power converter due o the object in the sensing area or charge area.

(7) The power transfer unit 1000 in the selection phase can detect an object, using at least one of detection methods using the induction coupling method and the resonant coupling method.

(8) The power transfer unit 1000 can perform an object detection process according to the power transfer methods and then select the method that detected the object from the coupling methods for wirelessly transferring power to progress to other phases.

(9) The power transfer unit 1000 in the selection phase generates a wireless power signal for detecting an object and a wireless power signal for digital detection, identification, configuration, and power transfer in the latter phases, and characteristics such as the frequency and the intensity of the wireless power signals may be different. This is for reducing power consumption by the power transfer unit 1000 in an idle phase or for being able to generate a specialized signal to detect an object because the selection phase of the power transfer unit 1000 corresponds to an idle phase for detecting an object.

[Ping Phase]

(1) In the ping phase, the power transfer unit 1000 can perform a process of detecting a power receiver unit 2000 in a sensing unit or a charge unit through a power control message. Compared with the process of detecting a power receiver unit 2000, using characteristics etc. of a wireless power signal in the selection phase, a detection process in the ping phase may be referred to as digital ping.

(2) The power transfer unit 1000 can generate a wireless power signal for detecting a power receiver unit 2000, demodulate a wireless power signal modulated by the power receiver unit 200, and obtain a power control message in a digital data format corresponding to a response to the detection signal from the demodulated wireless power signal.

(3) The power transfer unit 1000 can recognize the power receiver unit 2000 that is an objective of power transfer, by receiving the power control message corresponding to a response to the detection signal.

(4) The detection signal that is generated to perform a digital detection process by the power transfer unit 1000 in the ping phase may be a wireless power signal that is generated by applying power signal at a specific operating point for a predetermined time.

The operating point may mean the frequency, duty cycle, and amplitude of a voltage that is applied to the transfer-side coil unit 1400.

The power transfer unit 1000 can attempt to generate the detection signal generated by applying a power signal at the specific operating point for a predetermined time and receive a power control message from the power receiver unit 2000.

(5) The power control message corresponding to a response to the detection signal may be a message showing the strength of the wireless power signal received by the power receiver unit 2000. For example, the power receiver unit 2000 can transmit a signal strength packet including a message showing the strength of the wireless power signal received as a response to the detection signal. The packet may include a header showing that it is a packet and a message showing the strength of the power signal received by the power receiver unit 2000. The strength of the power signal in the message may be a value showing the degree of induction coupling or resonant coupling for power transfer between the power transfer unit 1000 and the power receiver unit 2000.

(6) The power transfer unit 1000 can enter the identification and pin phase by extending the digital ping after finding out the power receiver unit 2000 by receiving a response message to the detection signal. That is, the power transfer unit 1000 can receive a necessary power control message in the identification and ping phase to maintain a power signal at the specific operating point after finding out the power receiver unit 2000.

However, when the power transfer unit 1000 could not find out the power receiver unit that can transfer power, the operation state of the power transfer unit 1000 can return to the selection phase.

[Identification and Configuration Phase]

(1) In the identification and configuration phase, the power transfer unit 1000 can be controlled to efficiently transfer power by receiving identification information and/or configuration information transmitted from the power receiver unit 2000.

(2) In the identification and configuration phase, the power receiver unit 2000 can transmit a power control message including identification information thereof. To this end, the power receiver unit 2000, for example, can transmit an identification packet including a message showing the identification information of the power receiver unit 2000. The packet may include a header showing that it is a packet showing identification information and a message including the identification information of the power receiver unit 2000. The message may include information showing the version of a contract for wireless power transfer, information for identifying the manufacturer of the power receiver unit 2000, information showing whether there is an extended device identifier, and basic device identifier. When it is shown that there is an extended device identifier in the information showing whether there is an extended device identifier, an extended identification packet including the extended device identifier may be separately transmitted. The packet may include a header showing that it is a packet showing an extended device identifier and a message including the extended device identifier. When an extended device identifier is used, as described above, identification information of the manufacturer, and information based on the basic device identifier and the extended device identifier may be used to identify the power receiver unit 2000.

(3) In the identification and configuration phase, the power receiver unit 2000 can transmit a power control message including information about estimated maximum power. To this end, the power receiver unit 2000, for example, can transmit a configuration packet. The packet may include a header showing that it is a configuration packet and a message including information about the estimated maximum power. The message may include a power class, information about the estimated maximum power, an indicator showing a method of determining a current of a main cell of the power transfer unit 1000, and the number of selective configuration packets. The indicator may show whether the current of the main cell of the power transfer unit 1000 is determined in accordance with the contract for wireless power transfer.

(4) The power transfer unit 1000 can create a power transfer contract that is used for charge and the power receiver unit 2000 on the basis of the identification information and/or configuration information. The power transfer contract may include limits on parameters that determine a power transfer characteristic in the power transfer phase.

(5) The power transfer unit 1000 can end the identification and configuration phase and returns to the selection phase before entering the power transfer phase. For example, the power transfer unit 1000 can end the identification and configuration phase to find out another power receiver unit 2000 that can wirelessly receive power.

[Power Transfer Phase]

(1) The power transfer unit 1000 in the power transfer phase transfers power to the power receiver unit 2000.

(2) The power transfer unit 1000 can receive a power control message from the power receiver unit 2000 and adjust the characteristic of power supplied to the transfer coil unit 1400 in response to the received power control message while transferring power. For example, the power control message that is used to adjust the characteristic of the transfer coil may be included in a control error packet. The packet may include a header showing that it is a control error packet and a message including a control error value. The power transfer unit 1000 can adjust power that is supplied to the transfer coil in accordance with the control error value. That is, the current that is applied to the transfer coil may be maintained when the control error value is 0, can be reduced when the control error value is a negative value, and can be increased when the control error value is a positive value.

(3) In the power transfer phase, the power transfer unit 1000 can monitor parameters in the power transfer contract created on the basis of the identification information and/or configuration information. As the result of monitoring the parameters, when power transfer to the power receiver unit 2000 violates the limits included in the power transfer contract, the power transfer unit 1000 can cancel the power transfer and return to the selection phase.

(4) The power transfer unit 1000 can end the power transfer phase on the basis of the power control message transmitted from the power receiver unit 2000.

For example, when a battery is fully charged while the power receiver unit 2000 charges the battery using transferred power, the power receiver unit 2000 can transmit a power control message that request stopping of wireless power transfer to the power transfer unit 1000. In this case, the power transfer unit 1000 can end wireless power transfer and return to the selection phase after receiving the message that requests stopping of power transfer.

Alternatively, the power receiver unit 2000 can transmit a power control message that request renegotiation or reconfiguration to update the previously created power transfer contract. The power receiver unit 2000 can transmit a message that request renegotiation of the power transfer contract when a larger or smaller amount of power than the current transferred amount of power is required. In this case, the power transfer unit 1000 can end wireless power transfer and return to the identification and configuration phase after receiving the message that requests renegotiation of the power transfer contract.

To this end, the message that the power receiver unit 2000 transmits may be an end power transfer packet. The packet may include a header showing that it is an end power transfer packet and a message including end power transfer code showing the reason of the ending. The end power transfer code may show any one of charge complete, an internal fault, over temperature, over voltage, over current, battery failure, reconfiguration, no response, and unknown error.

Alternatively, when the power transfer unit 1000 senses that the load 2500 is being fully charged, it can end power transfer regardless of whether a message has been received from the power receiver unit 2000.

<Operation State of Power Transfer Unit>

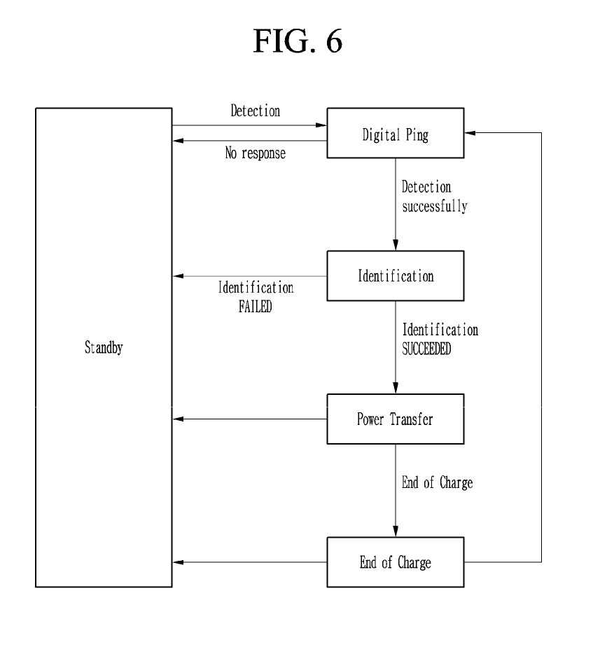

FIG. 6 is a diagram showing the operation flow of a wireless power transfer system, based on the operation state of a power transfer unit according to another embodiment.

Referring to FIG. 6, a power transfer unit according to another embodiment may have 1) a standby phase, 2) a digital ping phase, 3) an authentication phase, 4) a power transfer phase, and 5) an end of charge phase.

[Standby]

(1) When power is supplied to the power transfer unit 1000 and the power transfer unit 1000 is started, the power transfer unit 1000 may be in a standby phase. The power transfer unit 1000 in the standby phase can detect an object (for example, a power receiver unit 2000 or a metallic foreign object (FO)) in a sensing area or a charge area. Further, the power transfer unit 1000 can detect whether an object has been removed from the charge area.

(2) The power transfer unit 1000 can detect an object in the charge area by monitoring a change in magnetic flux, a change in capacitance between an object and the power transfer unit 1000, a change in inductance, or a shift of a resonant frequency, but it is not limited thereto.

(3) When detecting the power receiver unit 2000 in the charge area, the power transfer unit 1000 can progress to the digital ping phase that is the next step.

(4) When a foreign object (FO) such as a metallic foreign object is in the charge area, the power transfer unit 1000 can detect the foreign object.

(5) When the power transfer unit 1000 could not obtain sufficient information for discriminating the power receiver unit 2000 and the foreign object in the standby phase, the power transfer unit 1000 can progress to the digital ping phase or the authentication phase and check whether it is the power receiver unit 2000 or a foreign object (FO).

[Digital Ping]

(1) In the digital ping phase, the power transfer unit 1000 connects to a power receiver unit 2000 that can be charged and checks whether the power receiver unit 2000 can be charged with wireless power provided from the power transfer unit 1000. The power transfer unit 1000 can create and output digital pin having a predetermined frequency and timing to be connected with the chargeable power receiver unit 2000.

(2) When a sufficient power signal for digital ping is transmitted to the power receiver unit 200, the power receiver unit 2000 can respond to the digital ping by modulating the power signal in accordance with a communication protocol. When the power transfer unit 1000 receives an effective signal from the power receiver unit 2000, the power transfer unit 1000 can progress to the authentication phase without the power signal removed. When an end of charge (EOC) is received from the power receiver unit 2000 or when the power transfer unit 1000 senses that the load 2500 is being fully charged, the power transfer unit 1000 can progress to the end of charge phase.

(3) When an effective power receiver unit 2000 is not detected or when a response time of an object to the digital ping exceeds a predetermined time, the power transfer unit 1000 can remove the power signal and return to the standby phase. Accordingly, when a foreign object is disposed in the charge area, the foreign object cannot make any response, so the power transfer unit 1000 can return to the standby phase.

[Identification]

(1) When a response of the power receiver unit 2000 according to the digital ping of the power transfer unit 1000 is finished, the power transfer unit 1000 can check compatibility between the power transfer and receiver units 1000 and 2000 by transmitting power transfer unit authentication information to the power receiver unit 2000. When compatibility is found, the power receiver unit 2000 can transmit authentication information to the power transfer unit 1000. Further, the power transfer unit 1000 can check power receiver unit authentication information of the power receiver unit 2000.

(2) When the mutual authentication is finished, the power transfer unit 1000 can progress to the power transfer phase, or when authentication failed or a predetermined authentication time is exceeded, it can return to the standby phase.

[Power Transfer]

(1) The communication & control unit 1500 of the power transfer unit 1000 can provide charge power to the power receiver unit 2000 by controlling the power transfer unit 1000 on the basis of control data provided from the power receiver unit 2000.

(2) The power transfer unit 1000 can verity whether it goes out of an appropriate operation range or there is a problem with stability according to FOD.

(3) When power transfer unit 1000 receives a charge end request signal from the power receiver unit 2000 or senses that the load 2500 is being fully charged, or when a predetermined critical temperature value is exceeded, the power transfer unit 1000 can stop power transfer and progress to the end of charge phase.

(4) When the situation is changed into a situation not suitable for transferring power, the power signal can be removed and the standby phase can be returned. When the power receiver unit 2000 is removed and enters again the charge area, the cycle described above can be performed again.

(5) The power transfer unit 1000 can return to the authentication phase from the charge state of the load 2500 of the power receiver unit 2000 and can provide a charge power adjusted on the basis of phase information of the load to the power receiver unit 2000.

[End of Charge (EOC)]

(1) When the power transfer unit 1000 receives information showing that the power receiver unit 2000 has been charged, or senses that the load 2500 is being fully charged, or receives information showing that the temperature of the power receiver unit 2000 has increased to a predetermined temperature or more, the power transfer unit 1000 can progress to the end of charge phase.

(2) When the power transfer unit 1000 receives charge complete information from the power receiver unit 2000, or immediately after sensing that the load 2500 is being fully charged or when a predetermined time has passed after the sensing, the power transfer unit 1000 can stop power transfer and can stand by for a predetermined time. After the predetermined time passes, the power transfer unit 1000 can enter the digital ping phase to connect with the power receiver unit 2000 in the charge area.

(3) When the power transfer unit 1000 receives information showing that the predetermined temperature is exceeded from the power receiver unit 2000, the power transfer unit 1000 can stand by for a predetermined time. After the predetermined time passes, the power transfer unit 1000 can enter the digital ping phase to connect with the power receiver unit 2000 in the charge area.

(4) The power transfer unit 1000 can monitor whether the power receiver unit 2000 has been removed from the charge area for a predetermined time, and when the power receiver unit 2000 is removed from the charge area, the power transfer unit 1000 can return to the standby phase.

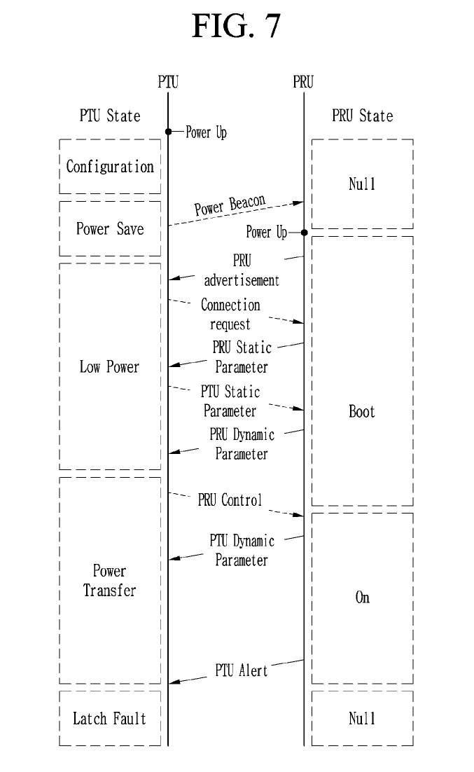

FIG. 7 is a diagram showing the operation flow of a wireless power transfer system according to another embodiment.

Operation State of Power Transfer Unit

Referring to FIG. 7, a power transfer unit 1000 according to another embodiment may have at least 1) a configuration mode 2) a power save mode, 3) a low power mode, 4) a power transfer mode, and 5) a latch fault mode.

[Configuration Mode]

(1) When power is supplied to the power transfer mode 1000 (Power Up), the configuration mode can be entered.

(2) The power transfer unit 1000 itself can check the system.

(3) The power transfer unit 1000 can maintain a current Iₜₓ_{_}ᵢₙ that is applied to the transfer-side coil 1400 at a specific current value (for example, 20 mArms) or less, and if the input current Iₜₓ_{_}ᵢₙ of the transfer-side coil 1400 is larger than the specific current value, it is possible to reduce the input voltage Iₜₓ_{_}ᵢₙ of the transfer-side coil 1400 to the specific current value or less within specific time (for example, 50 ms) after the power transfer unit 1000 entered the configuration mode.

(4) The power transfer unit 1000 can enter the power save mode within predetermined time (for example, 4s) after it entered the configuration mode.

[Power Save Mode]

(1) In the power save mode, the power transfer unit 1000 can apply different power beacons to the transfer-side coil 1400 at each period.

(2) The power beacons may include a short beacon and a long beacon and the short beacon can have a power amount required for detecting various power receiver units 2000. The long beacon can have a power amount required for driving the communication & control unit 2600 of the power receiver unit 2000. The long beacon can have a power amount that can maintain a sufficient voltage for inducing a response of the power receiver unit 2000 at the power receiver unit 2000. The short beacon can have a first period and the long beacon can have a second period. The short beacon may include a plurality of short beacons having different power amounts and the long beacon may include a plurality of long beacons having different power amounts.

(3) The power transfer unit 1000 can detect a change in reactance of input impedance Zₜₓ_{_}ᵢₙ, resistance of the input impedance Zₜₓ_{_}ᵢₙ, or the input impedance Zₜₓ_{_}ᵢₙ of the transfer-side coil 1400 and the transfer-side impedance matching unit 1300 while applying a shot beacon.

(4) When the power transfer unit 1000 detects a change in reactance of the input impedance Zₜₓ_{_}ᵢₙ, resistance of the input impedance Zₜₓ_{_}ᵢₙ, or the input impedance Zₜₓ_{_}ᵢₙ, it can immediately apply a long beacon.

(5) The power transfer unit 1000 can be driven by the long beacon of the power transfer unit 1000, and the power transfer unit 1000 can communicate with the power receiver unit 2000 on the basis of a predetermined method. When the power transfer unit 1000 receives advertisement from the power receiver unit 2000, it can enter the low power mode.

(6) When the power transfer unit 1000 could not detect a change in the input impedance Zₜₓ_{_}ᵢₙ itself or in reactance or resistance of the input impedance Zₜₓ_{_}ᵢₙ, it can maintain the power save mode.

(7) When the power transfer unit 1000 detected a change in the input impedance Zₜₓ_{_}ᵢₙ itself or in reactance or resistance of the input impedance Zₜₓ_{_}ᵢₙ, it can determine that an object exists in the charging area and enter the low power mode.

[Low Power Mode]

(1) In the low power mode, the power transfer unit 1000 and the power receiver unit 2000 can be connected by a predetermined communication method (for example, Bluetooth low energy (BLE) and can transmit and receive data, and the power receiver unit 2000 can join a wireless power network that the power transfer unit 1000 manages. The power transfer unit 1000 can enter the power transfer mode. The power transfer unit 1000 can sense an object positioned on a transfer pad, using a beacon signal, and determine whether the object is a device that can wirelessly receive power. The beacon signal may use a short beacon and a long beacon. The power receiver unit 2000 (or the reception-side communication & control unit) receiving the long beacon signal can be woken up (or powered up) and can transmit an advertisement (PRU advertisement) to the power transfer unit 1000.

(2) The power transfer unit 1000 receiving the advertisement (PRU advertisement) from the power receiver unit 2000 can form connection between the power transfer unit 1000 and the power receiver unit 2000 by transmitting a connection request signal to the power receiver unit 2000.

2-1) When the power receiver unit 2000 receives the connection request signal from the power transfer unit 1000, the power receiver unit 2000 can transmit power receiver unit power receiver unit parameter information to the power transfer unit 1000 (or the power transfer unit 1000 can read information from the power receiver unit 2000) and the power transfer unit 1000 can also transmit power transfer unit parameter information to the power receiver unit 2000 (or the power transfer unit 1000 can write information on the power receiver unit 2000). The PRU parameter information, which is information about the output voltage V_{rect} of the reception-side AC/DC converter 2300, may include the minimum output voltage V_{rect}_{_}ₘᵢₙ, the maximum output voltage V_{rect}_{_}ₘₐₓ, and the optimum output voltage V_{rect}_{_}ₛₑₜ. The optimum output voltage may have any one voltage value of values over the minimum output voltage V_{rect}_{_}ₘᵢₙ and under the maximum output voltage V_{rect}_{_}ₘₐₓ.

2-2) In detail, the power transfer unit can receive a power receiver unit static parameter from the power receiver unit 2000. The power receiver unit static parameter may be state information previous fixed as a signal indicating the state of the power receiver unit 2000. The power receiver unit static parameter may include selective filed information, protocol information, information about the output voltage V_{rect} of the reception-side AC/DC converter 2300, information about the output power of the reception-side AC/DC converter 2300.

2-3) The power transfer unit 1000 receiving the power receiver unit static parameter can transmit a power transmitter unit parameter (PTU static parameter) to the power receiver unit 2000. The power transmitter unit parameter (PTU static parameter) may be a signal indicating the capability of the power transfer unit 1000.

2-4) The power transfer unit 1000 can receive a power receiver unit dynamic parameter (PRU dynamic parameter) from the power receiver unit 2000. The power receiver unit dynamic parameter may include at least one item of parameter information measured by the power receiver unit 2000. For example, the power receiver unit dynamic parameter may include information about the output voltage V_{rect} of the reception-side AC/DC converter 2300. The power receiver unit dynamic parameter can include and provide a set voltage value rearranged in accordance with the wireless charge situation to the power transfer unit 1000 and the power transfer unit 1000 can update a power receiver unit control table on a registry, that is, an initially set voltage value of the power receiver unit static parameter to fit the situation on the basis of the rearranged set voltage value. The power transfer unit 1000 can control power transfer on the basis of the recently updated set value.

2-5) The power receiver unit dynamic parameter may include selective field information, information about the output voltage V_{rect}_{_}_{dyn} of the reception-side AC/DC converter 2300, the minimum output voltage V_{rect}_{_}ₘᵢₙ_{_}_{dyn} of the reception-side AC/DC converter 2300, the maximum output voltage V_{rect}_{_}ₘₐₓ_{_}_{dyn} of the reception-side AC/DC converter 2300, the optimum output voltage V_{rect}_{_}ₛₑₜ_{_}_{dyn} of the reception-side AC/DC converter 2300, and the output current of the reception-side AC/DC converter 2300, information about the output current of the reception-side DC/DC converter 2400, temperature information, alert information (PRU alert), etc.

2-6) The alert information may include information such as over voltage, over current, over temperature, charge complete, wire charge terminal lead-in detection (TA detect), SA mode/NSA mode transition, and restart request.

(3) When an object in the charging area is not the power receiver unit 200, but a metallic foreign object, data transmission and reception cannot be made between the power transfer unit 1000 and the object. Accordingly, when the power transfer unit 1000 could not receive a response from the object for a predetermined time, it can determine that the object is a foreign object and enter the latch fault mode.

[Latch Fault Mode]

(1) When the power transfer unit 1000 enters the latch fault mode, the power transfer unit 1000 can periodically apply a short beacon to the reception-side coil unit 400 (that is, transmit a short beacon to the power receiver unit 2000).

(2) When the power transfer unit 1000 detected a change in the input impedance Zₜₓ_{_}ᵢₙ itself or in reactance or resistance of the input impedance Zₜₓ_{_}ᵢₙ from the short beacon, it can determine that an object is out of the charging area and enter the power save mode or a configuration state.

(3) When the power transfer unit 1000 could not detect a change in the input impedance Zₜₓ_{_}ᵢₙ itself or in reactance or resistance of the input impedance Zₜₓ_{_}ᵢₙ, it can determine that the object has not been recovered and inform a user that the current state of the power transfer unit 1000 is an error state. Accordingly, the power transfer unit 1000 may include a lamp or an output unit that displays an alert such as an alarm.

(4) The latch fault mode may have various latch fault mode enter conditions other than the case in which an object is a foreign object. For example, when there is an error situation corresponding to the alarm information, the power transfer unit 1000 can enter the latch fault mode.

[Power Transfer Mode]

(1) The power transfer unit 1000 enters the power transfer mode, and the power transfer unit 1000 can output power receiver unit control information (PRU control) on the basis of the parameter information received from the power receiver unit 2000. The power receiver unit control information (PRU control) may include information that enables/disables charge of the power receiver unit 2000 and permission information. When the power transfer unit 1000 can provide power enough to charge the power receiver unit 2000, it can output the power receiver unit control information (PRU control) including enabling information.

(2) The power transfer unit 1000 can provide the power receiver unit control information power receiver unit control information (PRU control) to the power receiver unit 2000 at least periodically or in accordance with a necessity of changing the state of the power receiver unit 2000. The power receiver unit 2000 can change the state on the basis of the power receiver unit control information (PRU control) and output the power receiver unit dynamic parameter to the power transfer unit 1000 to report the state of the power receiver unit 2000. For example, the power receiver unit control information (PRU control) may include adjustment information to change the maximum power value Pₘₐₓ of the power receiver unit 2000 and the power receiver unit 2000 can transmit changed information to the power transfer unit 1000 by adjusting at least one of requested voltage/current information and the optimum output voltage of the reception-side AC/DC converter 2300 in accordance with the adjustment information.

As another embodiment, the power receiver unit control information (PRU control) may include adjustment information for changing the information about the output voltage V_{rect} of the reception-side AC/DC converter 2300 of the power receiver unit 2000 and the power receiver unit 2000 can adjust the requested voltage/current information or the optimum output voltage V_{rect}_{_}ₛₑₜ_{_}_{dyn} and the output voltage V_{rect} of the reception-side AC/DC converter 2300 and then transmit information about the adjustment to the power transfer unit 1000.

(3) The power receiver unit 2000 is permitted to be charged and power can be transferred from the power transfer unit 1000 to the power receiver unit 2000. The power transfer unit 1000 can periodically receive the power receiver unit dynamic parameter from the power receiver unit 2000. The power receiver unit dynamic parameter may include the state and temperature information of the wireless power receiver unit.

(4) The power receiver unit control information may include information for controlling the output voltage V_{rect} of the reception-side AC/DC converter 2300 of the power receiver unit 2000.

Alternatively, when the power transfer unit 1000 senses that the load 2500 is being fully charged, it can end power transfer regardless of whether information about full charge of the load 2500 has been received from the power receiver unit 2000.

Operation State of Power Receiver Unit

Referring to FIG. 7, the power receiver unit 2000 according to an embodiment may have at least 1) a null state, 2) a boot state, and 3) an on-state.

[Null State]

(1) The power receiver unit 2000 can become a null state when the output voltage V_{rect} of the reception-side AC/DC converter 2300 is less than a boot output voltage V_{rect}_{_}_{boot}.

(2) The power receiver unit 2000 can enter the null state when power is supplied to the power receiver unit 2000 (Power UP) and the output voltage V_{rect} of the reception-side AC/DC converter 2300 is less than the boot output voltage V_{rect}_{_}_{boot}.

(3) After going out of the null state, the power receiver unit 2000 can enter the null state when the output voltage V_{rect} of the reception-side AC/DC converter 2300 becomes an output voltage under a lock-out voltage (under voltage lock Out; V_{rect}_{_}_{UVLO}). The output voltage under a lock-out voltage (V_{rect}_{_}_{UVLO}) may be smaller than the boot output voltage (V_{rect}_{_}_{boot}).

[Boot State]

(1) The power receiver unit 2000 (or the reception-side communication & control unit) receiving a long beacon can be woken up (or powered up). When the power receiver unit 2000 has not been completely charged, it can transmit (or broadcast) an advertisement signal (PRU advertisement) and can wait a connection request from the power transfer unit 1000.

(2) The advertisement signal (PRU advertisement) can be periodically transmitted (or broadcasted) and the period may be changed over time. The power receiver unit 2000 can periodically transmit (or broadcast) the advertisement signal until it receives a connection request signal from the power transfer unit 1000.

(3) The power transfer unit 1000 can transmit a connection request signal for connecting to the power receiver unit 2000 on the basis of information included in the advertisement signal (PRU advertisement). When receiving the connection request signal for the advertisement signal (PRU advertisement) from the power transfer unit 1000 power receiver unit 2000, the power receiver unit 2000 and the power transfer unit 1000 can form connection. The power receiver unit 2000 can transmit a power receiver unit static parameter, receive a power transfer unit static signal from the power transfer unit 1000, and transmit a power receiver unit dynamic parameter to the power transfer unit 1000.

[On-State]

(1) The power receiver unit 2000 receives power receiver unit control information (PRU control) from the power transfer unit 1000, and when it is enabled by the power receiver unit control information (PRU control), it becomes the on-state and can receive power from the power transfer unit 1000.

(2) The power receiver unit 2000 can provide state information thereof by transmitting a power receiver unit dynamic parameter to the power transfer unit 1000.

Procedure of Setting Charge Voltage

(1) When wireless charge permission information about the power transfer unit 1000 is included in the power receiver unit control unit (PRU control) provided from the power transfer unit 1000 to the power receiver unit 2000, wireless charging can be started.

(2) The power transfer unit 1000 can transmit charge power on the basis of the power receiver unit static parameter.

(3) The power transfer unit 1000 can adjust the charge power on the basis of the power receiver unit dynamic parameter reflecting the state information of the power receiver unit 2000.

The charge power adjustment is an operation of the power receiver unit 2000 corresponding to description about the low power state and the power transfer state, so it is not described in detail. However, the description may be applied also to embodiments of the power receiver unit 2000.

[Method of Sensing Progress of Full Charge Step of Load]

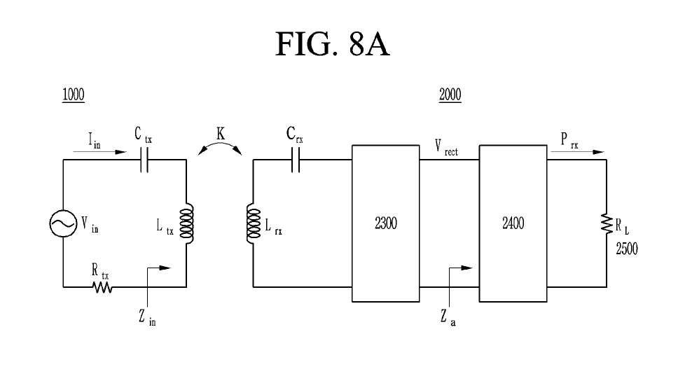

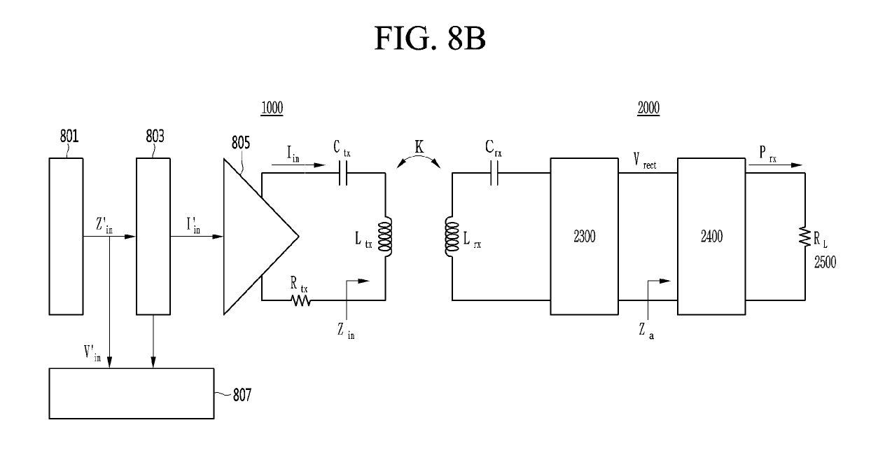

FIGS. 8A and 8B are equivalent circuit diagrams of a power transfer unit and a power receiver unit.

Referring to FIG. 8A, the transfer-side impedance matching unit 1300 and the transfer coil unit 1400 of the power transfer unit 1000 can be expressed as an equivalent circuit of a transfer-side resistor Rₜₓ, a transfer-side capacitor Cₜₓ, and a transfer-side inductor Iₜₓ, and the transfer-side capacitor Cₜₓ, and transfer-side inductor Lₜₓ are expressed in series, but they are not limited thereto and may be expressed in parallel. An output power Pᵢₙ from the transfer-side DC/AC converter 1200 can be provided to the transfer-side impedance matching unit 1300 and the transfer coil unit 1400. The output power can be determined by product of an output voltage Vᵢₙ (or it may be referred to as an input voltage to the transfer-side impedance matching unit 1300 or the transfer coil unit 1400) and an output current Iᵢₙ (or it may be referred to as an input current to the transfer-side impedance matching unit 1300 or the transfer coil unit 1400) of the DC/AC converter 1200.

The reception-side coil unit 2100 and the reception-side impedance matching unit 2200 of the power receiver unit 2000 can be expressed as an equivalent circuit of a reception-side inductor Lᵣₓ and a reception-side capacitor Cᵣₓ, and the reception-side inductor Lᵣₓ and reception-side capacitor Cᵣₓ are expressed in series, but are not limited thereto and may be expressed in parallel.

transfer-side of the power transfer unit 1000 can be magnetically coupled to the reception-side inductor Lᵣₓ of the power receiver unit 2000.

2) A input resistance Rₐ that is a natural number part of input impedance Zₐ of a DC/DC converter 2400 of the power receiver unit 2000 when the load 2500 is seen from an input port of the DC/DC converter 2400 can be expressed as Equation 3 by output power Pᵣₓ of the DC/DC converter 2400 and an input voltage of the DC/DC converter 2400, that is, a output voltage V_{rect} of the reception-side AC/DC converter 2300.

$${R}_{a} = \frac{{V}_{rect}^{2}}{{P}_{rx}} \qquad Equation 3$$

The output power Pᵣₓ can be defined as product of the effective values of the output voltage V_{rect} and a output current Iᵣₓ of the reception-side AC/DC converter 2300. Accordingly, output power Pᵣₓ of the reception-side AC/DC converter 2300 can be considered as being provided to the load 2500 via the DC/DC converter 2400.

Input impedance Zᵢₙ₁ (input impedance of the resonant circuit unit 102) when the power receiver unit 2000 is seen from an input port of the transfer-side impedance matching unit 1300 in a resonant state of the power transfer unit 1000 and the power receiver unit 2000 can be expressed as Equation 4.

$$Real \{ {Z}_{in} \} = \frac{{ω}^{2} {K}^{2} {L}_{tx} {L}_{rx}}{{R}_{a}} = \frac{{P}_{rx}}{{V}_{rect}^{2}} {ω}^{2} {K}^{2} {L}_{tx} {L}_{rx} \qquad Equation 4$$

Input power Pᵢₙ that is output from the transfer-side DC/AC converter 1200 and the transfer-side impedance matching unit 1300 (that is, input power of the resonance circuit unit 102) can be expressed as Equation 5.

$${P}_{in} = \frac{{V}_{in}^{2}}{Real \{ {Z}_{in} \}} = \frac{{V}_{rect}^{2} {V}_{in}^{2}}{{P}_{rx} {ω}^{2} {K}^{2} {L}_{tx} {L}_{rx}} \qquad Equation 5$$

A transfer efficiency can be expressed as Equation 6 from the ratio of input power Pᵢₙ and output power Pᵣₓ.

$${P}_{in} = \frac{{P}_{rx}}{transfer efficiency} \qquad Equation 6$$

Equation 7 can be obtained from Equations 5 and 6.

$${P}_{in} = \frac{{V}_{in}^{2}}{Real \{ {Z}_{in} \}} = \frac{{V}_{rect}^{2} {{V}^{2}}_{in}}{{P}_{rx} {ω}^{2} {K}_{2} {L}_{tx} {L}_{rx}} = \frac{{P}_{rx}}{transfer efficiency} \qquad Equation 7$$

Equation 8 can be obtained by arranging Equation 7.

$${V}_{in} = \frac{{P}_{rx} ω K}{{V}_{rect}} \sqrt{\frac{{L}_{tx} {L}_{rx}}{transfer efficiency}} \qquad Equation 8$$

The input power Pᵢₙ satisfies Equation 9.

According to Equation 9, it can be seen that, assuming that the coupling coefficient K and the transfer efficiency are constant, when the reception-side output power Pᵣₓ, is increased, the transfer-side input voltage Vᵢₙ is increased, while the reception-side output power Pᵣₓ is increased, the transfer-side input voltage Vᵢₙ is decreased. Accordingly, it can be seen that reception-side output power Pᵣₓ and the transfer-side input voltage Vᵢₙ are in proportion to each other.

$${P}_{in} = {I}_{in}^{2} Real ( {Z}_{in} ) = {I}_{in}^{2} \frac{{P}_{rx}}{{V}_{rect}^{2}} {ω}^{2} {K}^{2} {L}_{tx} {L}_{rx} = \frac{{P}_{rx}}{transfer efficiency} \qquad Equation 9$$

Equation 10 is satisfied by arranging Equation 9 for an input current Iᵢₙ.

$${I}_{in} = \frac{{V}_{rect}}{ω K} \sqrt{\frac{1}{transfer efficiency \times {L}_{tx} {L}_{rx}}} \qquad Equation 10$$

According to Equation 10, it can be seen that the transfer-side input current Iᵢₙ is irrelevant to the reception-side output power Pᵣₓ, the transfer-side input current Iᵢₙ is maintained when the output voltage V_{rect} of the reception-side AC/DC converter 2300, the coupling coefficient K, and the transfer efficiency are constant.

Although, in the above description referring to Equations 3 to 10, the transfer-side input voltage Vᵢₙ and the transfer-side input current Iᵢₙ are the voltage and current applied to the transfer coil unit 1400, in detail, the voltage and current applied to the transfer-side impedance matching unit 1300, they are not limited thereto and may be applied in the same way to the output voltage and output current of the transfer-side DC/DC converter 1120 or the input voltage and the input current of the transfer-side DC/AC converter 1200.

Referring to FIG. 8A, in accordance with another embodiment, the power transfer unit 1000 may further include a DC/DC converter 801, a current sensor 803, an amplifier 805, and a controller 807.

The amplifier 805 can be connected in series to a transfer-side resistor Rₜₓ and a transfer-side capacitor Cₜₓ. The controller 807 can sense an input voltage V′ᵢₙ from the DC/DC converter 801. The current sensor 803 can measure input impedance Z′ᵢₙ from the DC/DC converter 801. The controller 807 can sense the magnitude of the input voltage I′ᵢₙ from the input impedance Z′ᵢₙ sensed through the current sensor 803. It is possible to measure an input voltage Vᵢₙ and an input current Iᵢₙ by measuring the input voltage V′ᵢₙ and input current I′ᵢₙ of the input impedance Z′ᵢₙ that is in proportion to the input impedance Zᵢₙ of the power transfer unit 1000.

According to the power transfer unit 1000, when the input voltage Vᵢₙ and the input current Iᵢₙ are directly measured, as in FIG. 8A, a problem may occur in terms of cost and loss. The power transfer unit 1000 can solve the problem by measuring the input voltage V′ᵢₙ and input current I′ᵢₙ of the input impedance Z′ᵢₙ that is in proportion to the input impedance Zᵢₙ through the DC/DC converter 801, the current sensor 803, the amplifier 805, and the controller 807.

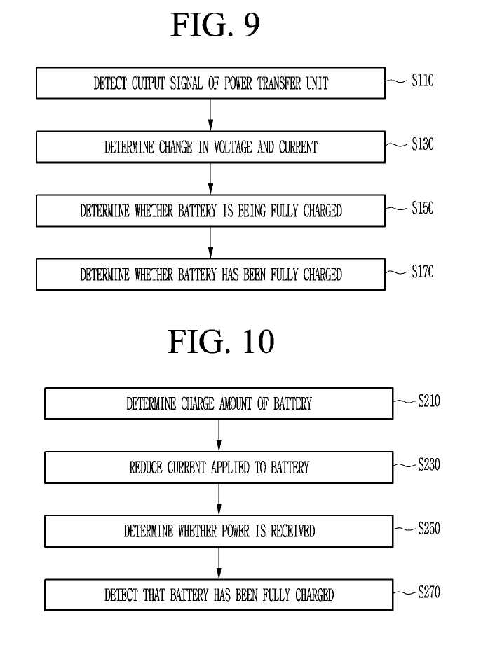

FIG. 9 is a diagram showing the operation flow of a power transfer unit according to an embodiment and FIG. 10 is a diagram showing the operation flow of a power receiver unit according to an embodiment.

A step in which the power transfer unit 1000 determines whether the power receiver unit 2000 has been full charged is described with reference to FIGS. 9 and 10. The power transfer unit 1000 performs 1) a step of detecting an output signal from the power transfer unit 1000 (S110), 2) a step of determining a change in the output signal (S130), and 3) a step of sensing that the battery 2510 receiving wireless power from the power transfer unit 1000 is being fully charged on the basis of the voltage and current (S150), thereby being able to determine whether the battery has been fully charged (S170).

The step of detecting an output signal from the power transfer unit (S110) can detect an output voltage and an output current of the power transfer unit 100 or detect an output current o the power transfer unit 1000, in which the output voltage of the power transfer unit 1000 can be estimated on the basis of an output voltage instruction value to be described below.

The step of determining a change in voltage and current, in detail, may be a step that determines whether the voltage has changed and the current has been maintained for a predetermined time. In more detail, the step of determining whether the voltage has changed may be a step that determines whether the voltage continuously decreases. That is, when the power transfer unit 1000 determines that a voltage decreases, but a current is maintained, it senses that the battery 2510 is being fully charged and can stop wireless power transfer. The voltage and current may be the output voltage and output current of the DC/DC converter 1120 of the power transfer unit 1000. Alternatively, whether the output voltage changes may be determined on the basis of whether the output voltage instruction value of the DC/DC converter 1120 changes.

The output voltage instruction value is a target value of the output voltage of the DC/DC converter 1120 and the DC/DC converter 1120 can be controlled by the transfer-side controller 1510 to be able to output an output voltage corresponding to the output voltage instruction value. When the reception-side output power Pᵣₓ decreases as the battery 2510 is being fully charged, the power transfer unit 1000 can decrease the transfer-side input voltage Vᵢₙ such that the power amount transferred from the transfer coil unit 1400, that is, the transfer-side input power Pᵢₙ decreases. In this case, the transfer-side controller 1510 can decrease the output voltage instruction value such that the output voltage of the DC/DC converter 1120 decreases. Accordingly, it is possible to determine that the output voltage of the DC/DC converter 1120 decreases by determining whether the output voltage instruction value decreases. Alternatively, the voltage and current may be the input voltage and current of the transfer-side coil unit 1400 of the power transfer unit 1000.

When the power transfer unit 100 determines that the battery 2510 is being fully charged and stops wireless power transfer, the power transfer unit 100 can transmit a wireless power transfer stop message to the power receiver unit 2000.

A method of driving the power receiver unit 2000 charging the battery 2510 wirelessly receiving power from the power transfer unit 100 is described. The power receiver unit 2000 can perform 1) a step of determining whether the charge amount of the battery 2510 is a first charge amount to a second charge amount larger than the first charge amount (S210), 2) a power reception step of decreasing a current applied to the battery 2510 when the charge amount of the battery 2510 is the first charge amount to the second charge amount (S230) (the current may be decreased step by step), 3) a step of determining that power reception from the power transfer unit 1000 sensing the decrease of the current has been stopped (S250), and 4) a charge end step that determines that the battery 2510 has been fully charged by determining that power reception from the power transfer unit 100 has been stopped (S270).

In this case, the first charge amount may be a charge amount indicating start of full charge of the battery 2510, the second charge amount may be a charge amount indicating completion of full charge of the battery 2510, and when the battery 2510 is in the first to second charge amount, it may be being fully charged. In the power reception step (S230), the voltage applied to the battery 2510 may be constant.

The power receiver unit 2000 determines by itself whether the battery 2510 has been fully charged after it was being fully charged and transmits a message including information showing that the battery 2510 has been fully charged, so the power transfer unit 1000 can check whether the battery 2510 has been fully charged and stop wireless power transfer. However, according to an embodiment of the present invention, the power transfer unit 1000 can determine by itself whether the battery 2510 has been fully charged even if the power receiver unit 2000 does not transmit separate full charge state information to the power transfer unit 1000. Further, the power receiver unit 2000 can determine whether the battery 2510 has been fully charged, by determining that wireless power has not been received, without checking by itself the charge amount of the battery 2510 in order to determine whether the battery 2150 has been fully charged.

An example of a method of checking a full charge state by determining whether the battery 2510 is being fully charged is described in detail.

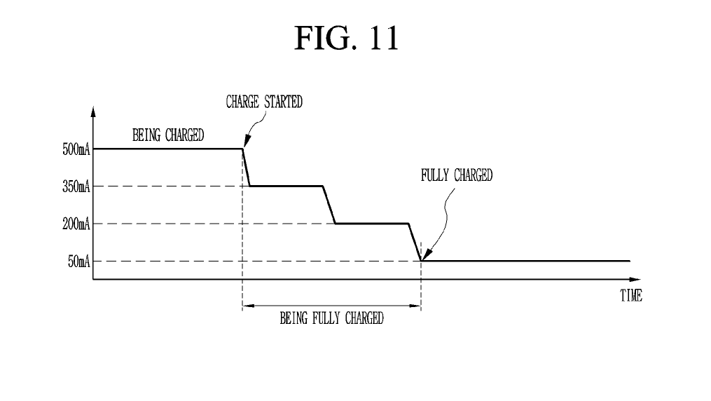

FIG. 11 is a graph showing the magnitude of a current applied to a battery in accordance with a full charge state of the battery over time.

Charging the battery 2510 of the load 2500 can be finished through a charge state that is a first step, a full charge state that is a second step, a full charge-progressing state that is a third step, and a full charge completion state that is a fourth step, that is, charging can be completed through the first to fourth steps.

A voltage and current that are applied to the battery 2510 in accordance with the first to fourths steps are described. The voltage that is applied to the battery 2510 in accordance with the first to fourth steps may have a fixed value (or an approximately constant value). The current that is applied to the battery 2510 may have a constant current value in the first step and may be reduced continuously or step by step through the second to fourth steps.

For example, referring to FIG. 11, a voltage and a current applied to the battery 2510 during charging that is the first step may be 5V and 50 mA, respectively, and the voltage and current applied to the battery 2510 in the full charge start state that is the second step may be 5V and reduced to 350 mA, respectively. The voltage and current applied to the battery 2510 in the full charge-progressing state that is the third step may be 5V and decreased to 200 mA, respectively. The voltage and current applied to the battery 2510 in the full charge completion state that is the fourth step may be 5V and decreased to 50mA, respectively.

That is, the current applied to the battery 2510 may be decreased step by step through the first to fourth steps. The first to fourth steps are divided for the convenience of description but may be more finely divided, and the degree of decrease in current may be changed by more finely dividing the full charge-progressing state that is the third step. In this case, the current can be continuously decreased through the steps. The current that flows to the battery 2510 may be reduced step by step under control of the battery manager 2520. As the battery 2510 is gradually fully charged, in order to prevent overcharging, the battery manager 2520 reduces the charge speed by reducing the current amount applied to the battery 2510 when the battery 2510 is almost fully charged.

Unlike the figure, the current applied to the battery 2510 is constant in the charge-progress state that is the first step, but the current is not limited thereto and may be changed in a predetermined range. The charge amount of the battery 2510 for discriminating the first step and the second step may depend on the kind of the battery 2510. For example, the charge amount of the battery 2510 may be less than 90% in the first step, 90% in the second step, larger than 90% and less than 98% in the third step, and 90% or more in the fourth step.

When the charge capability of the battery 2510 becomes a predetermined value or more while the battery 2510 is being charged, the full charge start state may be entered, and after the full charge-progressing state, the full charge completion state may be entered. In this process, the output power Pᵣₓ applied to the load 2500 may be defined as product of the voltage and current applied to the battery 2510, and the output power Pᵣₓ may also be reduced step by step in correspondence to the decrease of the current, as the current is reduced step by step in full charge-progressing.

When the output power Pᵣₓ is reduced in accordance with Equation 6 with the transfer efficiency maintained, the input power Pᵢₙ can also be reduced in correspondence to the reduction of the output power Pᵣₓ. Further, since the input current Iᵢₙ is constant regardless of the reduction of the output power Pᵣₓ, the input voltage Vᵢₙ can be reduced in correspondence to the reduction of the input power Pᵢₙ that is defined as product of the input voltage Vᵢₙ and input current Iᵢₙ.

Accordingly, the transfer-side controller 1510 can determine the full charge-progressing progressing state of the battery 2510 by determining a change in the input voltage Vᵢₙ and input current detected by the detector 1600. That is, the power transfer unit 1000 can determine that the battery 2510 is being fully charged by measuring the output voltage Vᵢₙ₁ and output current Iᵢₙ₁ of the transfer-side AC/DC converter 1100 or the input voltage Vᵢₙ₂ and input current Iᵢₙ₂ of the transfer coil unit 1400. In detail, the detector 1600 of the power transfer unit 1000 can detect the output current Iᵢₙ₁ of the transfer-side AC/DC converter 1100 or the input current Iᵢₙ₁ of the transfer-side DC/AC converter 1200. Further, the detector 1600 can detect the output voltage Vᵢₙ₁ of the transfer-side AC/DC converter 1100 or the output voltage Vᵢₙ₁ of the transfer-side DC/AC converter 1200. Further, it is possible to detect the output voltage Vᵢₙ₂ of the transfer-side DC/AC converter 1200, the output current Iᵢₙ₂, or the input voltage Vᵢₙ₂ and input current Iᵢₙ₂ applied to the transfer coil unit 1400.

When the detector 1600 determines that the voltage is decreased step by step but the current is constant for a predetermined time period on the basis of the detected voltage and current, it can determine the battery is being fully charged. When the power transfer unit 1000 determines that the battery 2510 is being fully charged, it can stop wireless power transfer immediately or after a predetermined time passes. The point of time when the predetermined time passed may be the same as the point of time when the battery 2510 is fully charged, or a point of time before or after the point of time.

According to the embodiment, when the coupling coefficient K is changed, both of the input voltage Vᵢₙ and the input current are changed, but in the full charge-progressing state, the input current Iᵢₙ is fixed and the input voltage Vᵢₙ is changed. Accordingly, using this fact, the power transfer unit 1000 can determine whether to keep performing wireless power transfer by determining whether the batter 2510 is being fully charged. Further, before the power receiver unit 2000 provides information showing full charge completion to the power transfer unit 1000 when the battery 2510 is fully charged, the power transfer unit 1000 stops wireless power transfer, whereby it is possible to save power. Further, it is possible to prevent the problem that the transfer-side communication unit 1520 could not determine the full charge information of the battery 2510 from the power receiver unit 2000, thereby causing unnecessary power transfer and heat generation.

Although exemplary embodiments of the present invention were described above, it should be understood that the present invention may be changed and modified in various ways by those skilled in the art without departing from the spirit and scope of the present invention described in the following claims. Therefore, the technical scope of the present invention is not limited to the exemplary embodiments described herein, but should be determined by claims.

### INDUSTRIAL APPLICABILITY

The present invention can be used in the field of a wireless power transfer system.

1. A method of driving a power transfer unit wirelessly transferring power, the method comprising:
determining a change in a voltage and a current of the power transfer unit; and
determining whether a battery in a power receiver unit receiving wireless power from the power transfer unit is being fully charged on the basis of a change in the voltage and the current.

2. The method of claim 1, wherein the determining of a change in a voltage and a current
measures values of the voltage for a predetermined time and detects whether the measured values of the voltage are reduced, and
measures values of the current for a predetermined time and determines whether the measured values of the current are maintained.

3. The method of claim 2, wherein the determining whether the current is reduced determines whether the voltage is reduced step by step.

4. The method of claim 3, wherein when the batter is being fully charged, wireless power transfer is stopped.

5. The method of claim 1, wherein the voltage of an output voltage of a DC/DC converter of the power transfer unit, and
the current is an output current of a DC/DC converter of the power transfer unit.

6. The method of claim 1, wherein a change in a voltage of the power transfer unit is determined on the basis of an output voltage instruction value of the DC/DC converter.

7. The method of claim 1, wherein, the voltage and the current are an input voltage and an input current of a transfer-side coil of the power transfer unit.

8. A method of driving a power receiver unit charging a batter by wirelessly receiving power from a power transfer unit, the method comprising:
reducing step by step a current applied to the battery when a charge amount of the battery is a first charge amount to a second charge amount larger than the first charge amount;
determining whether power is transferred from the power transfer unit recognizing a reduction of the current; and
determining that the battery has been fully charged when power transfer from the power transfer unit is stopped.

9. The method of claim 8, wherein the first charge amount is a charge amount indicating a full charge start state of the battery,
the second charge amount is a charge amount indicating a full charge completion state of the battery, and
when the charge amount of the battery is within the range of the first to second charge amounts, the battery is being fully charged.

10. The method of claim 8, wherein a voltage applied to the battery in the reducing of a current applied to the battery is constant.

11. A power transfer wirelessly transferring power to a power receiver unit, comprising:
a DC/DC converter; and
a controller determining whether a battery of a power receiver unit, which receives wireless power from the power transfer unit, is being fully charged on the basis of a change in an output signal of the DC/DC converter.

12. The power transfer unit of claim 11, wherein the output signal is an output current and an output voltage of the DC/DC converter.

13. The power transfer unit of claim 12, further comprising a detector detecting the output current and the output voltage.

14. The power transfer unit of claim 12, further comprising a detector detecting the output current,
wherein the controller adjusts an output voltage for the DC/DC converter on the basis of an output voltage instruction value, and
the controller determines a change in the output voltage on the basis of the output voltage instruction value.

15. The power transfer unit of claim 12, wherein whether the output current is constant and the output voltage is reduced step by step for a predetermined time is determined.

16. The power transfer unit of claim 14, wherein whether the output current is constant and the output voltage instruction value is reduced step by step for a predetermined time is determined.

17. The power transfer unit of claim 11, wherein when the power transfer unit determines that the battery is being fully charged, the power transfer unit stops wireless power transfer after a predetermined time passes.

18. The power transfer unit of claim 11, wherein the power receiver unit comprises:
a receiver-side coil receiving the power;
a battery charged with the power; and
a battery manager controlling the battery,
wherein the battery manager
reduces step by step a current applied to the battery when a charge amount of the battery is a first charge amount to a second charge amount larger than the first charge amount, and
determines that the battery has been fully charged when power transfer from the power transfer unit recognizing the reduction of the current is stopped.

19. The power transfer unit of claim 18, wherein the battery manager determines that the first charge amount is a charge amount indicating a full charge start state of the battery, that the second charge amount is a charge amount indicating a full charge completion state of the battery, and that the battery is being fully charged when the charge amount of the battery is within the range of the first to second charge amounts.

20. The power transfer unit of claim 18, wherein the power receiver unit receives a message of stopping wireless power transfer from the power transfer unit recognizing the reduction of the current.
